(19) United States
(12) Patent Application Publication
(10) Pub. No.: US 2026/0135591 A1
(43) Pub. Date: May 14, 2026

(54) METHOD AND APPARATUS FOR CONTROLLING CHANNEL CHARACTERISTICS IN COMMUNICATION SYSTEM

(71) Applicant: ELECTRONICS AND TELECOMMUNICATIONS RESEARCH INSTITUTE, Daejeon (KR)

(72) Inventor: Hyung Sik JU, Daejeon (KR)

(73) Assignee: ELECTRONICS AND TELECOMMUNICATIONS RESEARCH INSTITUTE, Daejeon (KR)

(21) Appl. No.: 19/380,545

(22) Filed: Nov. 5, 2025

(30) Foreign Application Priority Data
Nov. 12, 2024 (KR) 10-2024-0160368
Oct. 20, 2025 (KR) 10-2025-0152030

(51) Int. Cl. H04B 7/04; H04L 25/02; H04L 27/26

(52) U.S. Cl. CPC H04B 7/04013; H04L 25/0242; H04L 27/261

(57) ABSTRACT

A method of a network controlled repeater (NCR) may comprise: determining a rank of a backhaul link between a base station and the NCR; receiving access link configuration information from the base station; determining, among a plurality of reconfigurable intelligent surface (RIS) panels, at least one RIS panel according to the determined rank and the access link configuration information; transmitting RIS configuration information to the at least one RIS panel; and transmitting at least one signal to the at least one RIS panel through at least one access link beam.

### CROSS-REFERENCE TO RELATED APPLICATIONS

This application claims priority to Korean Patent Applications No. 10-2024-0160368, filed on November 12, 2024, and No. 10-2025-0152030, filed on October 20, 2025, with the Korean Intellectual Property Office (KIPO), the entire contents of which are hereby incorporated by reference.

### BACKGROUND

### 1. Technical Field

The present disclosure relates to a channel characteristic control technique in a communication system, and more particularly, to a channel characteristic control technique in a communication system, which is for a network controlled repeater to control a reconfigurable intelligent surface (RIS) by reflecting channel characteristics.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

In such a communication system, mobile network operators may consider different types of network nodes to increase coverage flexibility for network deployment. For example, a network node may be an integrated access and backhaul (IAB). As another example, a network node may be a radio frequency (RF) repeater. The RF repeater can amplify and forward a received signal. As yet another example, a network node may be a network controlled repeater (NCR). The NCR can receive side control information from a network and operate based on the side control information, thereby providing enhanced functionality compared to the RF repeater. Such a network controlled repeater may need to control access link beamforming and the scattering characteristics of a channel based on side control information received from a base station for performance enhancement.

### SUMMARY

The present disclosure is directed to providing methods and apparatuses for controlling channel characteristics in a communication system, in which a network controlled repeater controls a reconfigurable intelligent surface (RIS) based on channel characteristics.

According to a first exemplary embodiment of the present disclosure, a method of a network controlled repeater (NCR) may comprise: determining a rank of a backhaul link between a base station and the NCR; receiving access link configuration information from the base station; determining, among a plurality of reconfigurable intelligent surface (RIS) panels, at least one RIS panel according to the determined rank and the access link configuration information; transmitting RIS configuration information to the at least one RIS panel; and transmitting at least one signal to the at least one RIS panel through at least one access link beam.

The determining of the rank of the backhaul link may comprise: receiving a reference signal from the base station; and determining the rank of the backhaul link based on the reference signal.

The determining of the rank of the backhaul link based on the reference signal may comprise: estimating a channel matrix based on the reference signal; performing singular value decomposition (SVD) on the channel matrix to generate singular values; and determining the rank based on a number and magnitudes of the singular values.

The determining of the at least one RIS panel according to the determined rank and the access link configuration information may comprise: based on the determined rank being a low rank, acquiring at least one beam generation direction of at least one access link beam from the access link configuration information; and determining, among the plurality of RIS panels, an RIS panel located in the at least one generation direction as the at least one RIS panel.

The determining of the at least one RIS panel according to the determined rank and the access link configuration information may comprise: based on the determined rank being a high rank, configuring N access link beams based on the access link configuration information; and determining, among the plurality of RIS panels, P RIS panels as the at least one RIS panel with reference to the N access link beams, where N and P are positive integers, and P is greater than or equal to N.

The transmitting of the RIS configuration information to the at least one RIS panel may comprise: generating the RIS configuration information including at least one of a reflection beam generation direction or a reflection power of the at least one RIS panel; and transmitting the generated RIS configuration information to the at least one RIS panel.

The transmitting of the RIS configuration information to the at least one RIS panel may comprise: grouping reflection elements of the at least one RIS panel to form at least one reflection element unit; generating the RIS configuration information including at least one of a reflection beam generation direction or a reflection power of the at least one reflection element unit; and transmitting the generated RIS configuration information to the at least one RIS panel.

The method may further comprise: receiving, from the base station, the RIS configuration information for the at least one RIS panel; and transmitting the RIS configuration information to the at least one RIS panel.

According to a second exemplary embodiment of the present disclosure, a network controlled repeater (NCR) may comprise at least one processor, and the at least one processor may cause the NCR to perform: determining a rank of a backhaul link between a base station and the NCR; receiving access link configuration information from the base station; determining, among a plurality of reconfigurable intelligent surface (RIS) panels, at least one RIS panel according to the determined rank and the access link configuration information; transmitting RIS configuration information to the at least one RIS panel; and transmitting at least one signal to the at least one RIS panel through at least one access link beam.

In the determining of the rank of the backhaul link, the at least one processor may cause the NCR to perform: receiving a reference signal from the base station; and determining the rank of the backhaul link based on the reference signal.

In the determining of the at least one RIS panel according to the determined rank and the access link configuration information, the at least one processor may cause the NCR to perform: based on the determined rank being a low rank, acquiring at least one beam generation direction of at least one access link beam from the access link configuration information; and determining, among the plurality of RIS panels, an RIS panel located in the at least one generation direction as the at least one RIS panel.

In the determining of the at least one RIS panel according to the determined rank and the access link configuration information, the at least one processor may cause the NCR to perform: based on the determined rank being a high rank and the access link configuration information indicating at least one access link beam, configuring N access link beams based on the indicated at least one access link beam; and determining, among the plurality of RIS panels, P RIS panels as the at least one RIS panel with reference to the N access link beams, where N and P are positive integers, and P is greater than or equal to N.

In the transmitting of the RIS configuration information to the at least one RIS panel, the at least one processor may cause the NCR to perform: grouping reflection elements of the at least one RIS panel to form at least one reflection element unit; generating the RIS configuration information including at least one of a reflection beam generation direction or a reflection power of the at least one reflection element unit; and transmitting the generated RIS configuration information to the at least one RIS panel.

The at least one processor may further cause the NCR to perform: receiving, from the base station, the RIS configuration information for the at least one RIS panel; and transmitting the RIS configuration information to the at least one RIS panel.

According to the present disclosure, an NCR can identify a rank of a backhaul link and may control RIS panel(s) based on the identified rank. When the backhaul link has a low rank, the NCR may transmit a signal to a terminal through RIS panel(s) located in a beam generation direction of an access link beam. When the backhaul link has a high rank, the NCR may transmit a signal to the terminal through a plurality of RIS panels. As described above, the NCR can efficiently transmit a signal to the terminal by transmitting the signal using the RIS panel(s) while reflecting a channel state of the backhaul link.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating exemplary embodiments of a communication system supporting a network controlled repeater.

FIG. 4 is a conceptual diagram illustrating exemplary embodiments of a protocol stack of an NCR that controls an RIS.

FIG. 5 is a conceptual diagram illustrating exemplary embodiments of a channel characteristic control method in a communication system.

FIG. 6 is a conceptual diagram illustrating exemplary embodiments of a channel characteristic control method in a communication system.

FIG. 7 is a conceptual diagram illustrating exemplary embodiments of a channel characteristic control method in a communication system.

FIG. 8 is a conceptual diagram illustrating exemplary embodiments of an RIS panel.

FIG. 9 is a flowchart illustrating exemplary embodiments of a channel characteristic control method in a communication system.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

In the present disclosure, a phrase including “when ~” may be expressed as a phrase including “based on ~” or a phrase including “in response to ~”. In other words, a phrase including “when ~” may be interpreted as the same as or similar to a phrase including “based on ~” or a phrase including “in response to ~”.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments according to the present disclosure will be described with respect to a communication system to which the exemplary embodiments are applied. The communication system to which the exemplary embodiments according to the present disclosure are applied is not limited to the content described below, and the exemplary embodiments according to the present disclosure may be applied to various communication systems. Here, the communication system may be used in the same sense as a communication network.

Throughout the present disclosure, a network may include, for example, wireless Internet such as wireless fidelity (WiFi), portable Internet such as wireless broadband internet (WiBro) or world interoperability for microwave access (WiMax), a 2G mobile communication network such as global system for mobile communication (GSM) or code division multiple access (CDMA), a 3G mobile communication network such as wideband code division multiple access (WCDMA) or CDMA2000, a 3.5G mobile communication network such as high speed downlink packet access (HSDPA) or high speed uplink packet access (HSUPA), a 4G mobile communication network such as long term evolution (LTE) network or LTE-Advanced network, a 5G mobile communication network, and a 6G mobile communication network.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, a base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

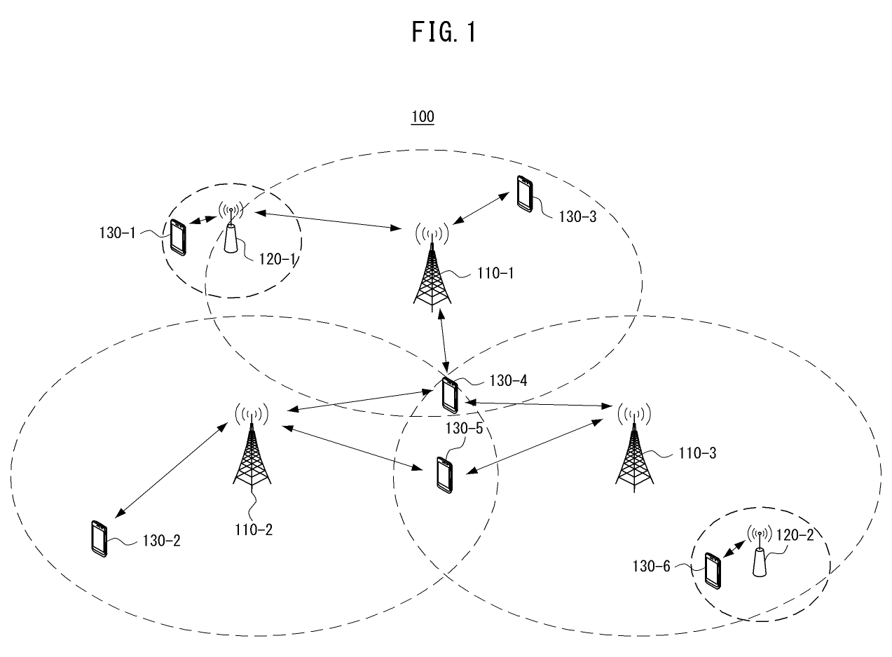

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4,130-5, and 130-6. The plurality of communication nodes may support 4G communication (e.g. long term evolution (LTE), LTE-advanced (LTE-A)), 5G communication (e.g. new radio (NR)), etc. specified in the 3rd generation partnership project (3GPP) standards. The 4G communication may be performed in frequency bands below 6GHz, and the 5G communication may be performed in frequency bands above 6GHz as well as frequency bands below 6GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1,110-2, 110-3, 120-1, 120-2, 130-1, 130-2, 130-3, 130-4, 130-5, and 130-6 constituting the communication system 100 may have the following structure.

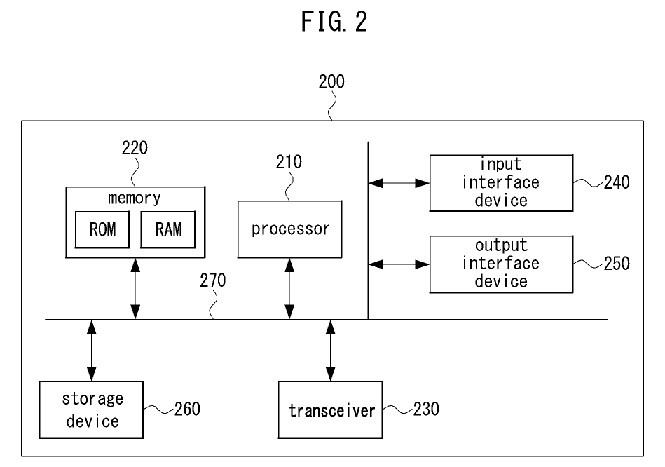

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4,130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, , 130- 4130-3, 130-5, and 130-6 may perform operations corresponding to the operations of the plurality of base stations 110-1, 110-2, 110-3, 120-1, and 120-2, and operations supported by the plurality of base stations 110-1, 110-2, 110-3,120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, in a communication system, wireless communication coverage may be a fundamental aspect of cellular network deployments, and mobile network operators may rely on different types of network nodes to facilitate comprehensive coverage of wireless communication system deployments. The deployment of regular full-stack cells may be one option, but due to the lack of backhaul availability, such deployment may not always be possible and may not be economically feasible. Consequently, mobile network operators may consider different types of network nodes to enhance flexibility in network deployment coverage.

One type of network node may be an integrated access and backhaul (IAB). The IAB may be a new type of network node that does not require a wired backhaul. Another type of network node may be a radio frequency (RF) repeater. The RF repeater may amplify and forward a received signal. The RF repeater may provide a cost-effective solution for extending network coverage. However, since the RF repeater simply performs amplify-and-forward operations, the RF repeater may have performance limitations. Various control elements that may improve the performance of the RF repeater may include information on downlink/uplink configuration, adaptive transceiver spatial beamforming, and ON-OFF state.

Yet another type of network node may be a network controlled repeater (NCR). The NCR may receive side control information from a network and operate based on the side control information, thereby providing improved functionality compared to the RF repeater. Here, the side control information may enable the network controlled repeater to perform amplify-and-forward operations in an efficient manner. Such a network controlled repeater may provide mitigation of unnecessary noise amplification, better spatially directed transmission and reception, and simplified network integration.

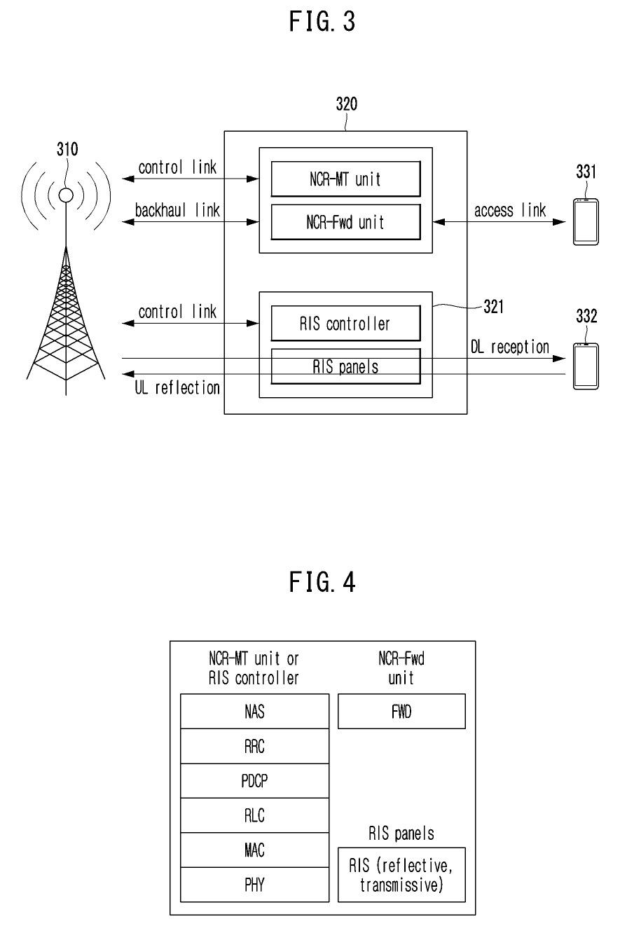

FIG. 3 is a conceptual diagram illustrating exemplary embodiments of a communication system supporting a network controlled repeater.

Referring to FIG. 3, a communication system may include a base station 310, an NCR 320, and terminals 331 and 332.

The NCR 320 may include an NCR-mobile termination (MT) unit and an NCR-forwarding (Fwd) unit (i.e. RF forwarding unit). The NCR-MT unit may be a functional entity that communicates with the base station 310 through a control link (C-link) to enable exchange of control information. The control information may be side control information (SCI) for controlling the NCR-Fwd unit. The control link may be based on a Uu interface of NR. The SCI is not limited to the terms described in the present disclosure and may use other terms having equivalent technical meanings, such as repeater-downlink control information (R-DCI), repeater control information (RCI), or network controlled repeater control information (NCI).

The NCR-Fwd unit may be a functional entity capable of amplifying and forwarding uplink (UL)/downlink (DL) RF signals between the base station 310 and the terminal 331 through an NCR-Fwd backhaul link and an NCR-Fwd access link. The NCR-MT unit may control operations of the NCR-Fwd unit according to SCI received from the base station 310.

In terms of repeater management, the NCR 320 may connect to the base station 310 according to a terminal access procedure of NR. The NCR-MT unit may establish a signaling radio bearer (SRB) between the NCR-MT unit and the base station 310. The NCR-MT unit may optionally establish a data radio bearer (DRB) between the NCR-MT unit and the base station 310. The established DRB may be used for transmitting operations, administration and management (OAM) traffic.

The NCR 320 may relay communication (e.g. DL and/or UL communication) between the base station 310 and the terminal 331. In case of downlink, the NCR 320 may receive a DL signal from the base station 310 and perform an operation of amplifying and forwarding the DL signal to the terminal 331. In case of uplink, the NCR 320 may receive a UL signal from the terminal 331 and perform an operation of amplifying and forwarding the UL signal to the base station 310.

The NCR 320 may include a reconfigurable intelligent surface (RIS) 321. The RIS 321 may include an RIS controller and a plurality of RIS panels. Each of the plurality of RIS panels may include a plurality of reflection elements. The RIS controller may be connected to the base station through a wired or wireless control link.

The RIS controller may adjust phases of reflection elements of corresponding RIS panel(s) under control of the base station, thereby reflecting a DL signal incident on the reflection elements of the RIS panel(s) toward the terminal 332. In addition, the RIS controller may adjust phases of reflection elements of corresponding RIS panel(s) under control of the base station, thereby reflecting a UL signal incident on the reflection elements of the RIS panel(s) toward the base station.

FIG. 4 is a conceptual diagram illustrating exemplary embodiments of a protocol stack of an NCR that controls an RIS.

Referring to FIG. 4, an NCR-MT unit of an NCR may have a protocol stack from a physical layer to a NAS layer. In other words, the NCR-MT unit may perform network layer functions of a medium access control (MAC) layer, a radio link control (RLC) layer, a packet data convergence protocol (PDCP) layer, a radio resource control (RRC) layer, and a NAS layer.

The NCR-MT unit may receive access link control information from the base station based on the protocol stack. The access link control information may include access link beam configuration information. The access link beam configuration information may include information on a beam generation direction and a transmission power for each access link beam.

The NCR-MT unit may decode the received access link control information and may obtain the access link beam configuration information from the decoded access link control information. The NCR-MT unit may control an NCR-Fwd unit according to the beam generation direction of each access link beam included in the access link beam configuration information, and may generate access link beams. The NCR-MT unit may transmit the generated access link beams with the transmission powers. The NCR-Fwd unit may perform a forwarding (FWD) layer function.

The RIS controller of the RIS may have a protocol stack from a physical layer to a NAS layer. In other words, the RIS controller may perform network layer functions from a MAC layer, RLC layer, PDCP layer, RRC layer, and NAS layer. The RIS controller may receive RIS control information from the base station based on the protocol stack. The RIS control information may include RIS panel configuration information for each RIS panel. The RIS panel configuration information may include information such as a beam generation direction and a reflection power for each RIS panel. The RIS controller may decode the received RIS control information and may control the RIS panels according to the decoded RIS control information. The RIS panels may be reflective or transmissive. Here, the NCR-MT unit and the RIS controller may be referred to as an NCR controller.

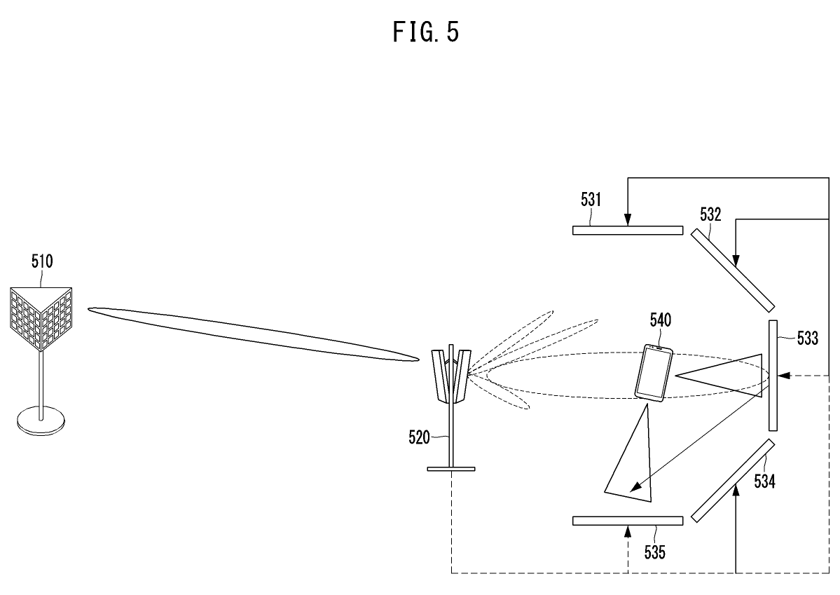

FIG. 5 is a conceptual diagram illustrating exemplary embodiments of a channel characteristic control method in a communication system.

Referring to FIG. 5, in a channel characteristic control method, a base station 510 may transmit access link control information to an NCR controller 520. The access link control information may include access link beam configuration information. The access link beam configuration information may include information on a beam generation direction and a transmission power for each access link beam. The NCR controller may receive the access link control information from the base station.

The NCR controller may decode the received access link control information and may obtain the access link beam configuration information from the decoded access link control information. The NCR controller may control an NCR-Fwd unit according to the beam generation direction of each access link beam included in the access link beam configuration information. The NCR-Fwd unit may generate access link beams under control of the NCR controller. The NCR-Fwd unit may transmit the generated access link beams with the transmission powers to RIS panels 531 to 535 and a terminal 540. The NCR-Fwd unit may perform an FWD layer function.

The base station may transmit RIS control information to the NCR controller. The RIS control information may include RIS panel configuration information for each of the RIS panels. The RIS panel configuration information may include configuration information for each RIS panel. The configuration information for each RIS panel may include information such as a beam generation direction and a reflection power for each RIS panel. The NCR controller may receive the RIS control information from the base station.

The NCR controller may decode the RIS control information and may obtain the RIS panel configuration information from the decoded RIS control information. The NCR controller may obtain configuration information for each RIS panel from the RIS panel configuration information. The NCR controller may transmit the configuration information for each RIS panel to the corresponding RIS panel. Each of the RIS panels may receive the configuration information for each RIS panel from the NCR controller.

Each RIS panel may reflect a beam received from the NCR-Fwd unit toward the terminal according to the beam generation direction and reflection power for each RIS panel based on the received configuration information for each RIS panel. Alternatively, each RIS panel may reflect a beam received from the terminal toward the NCR-Fwd unit according to the beam generation direction and reflection power for each RIS panel based on the received configuration information for each RIS panel.

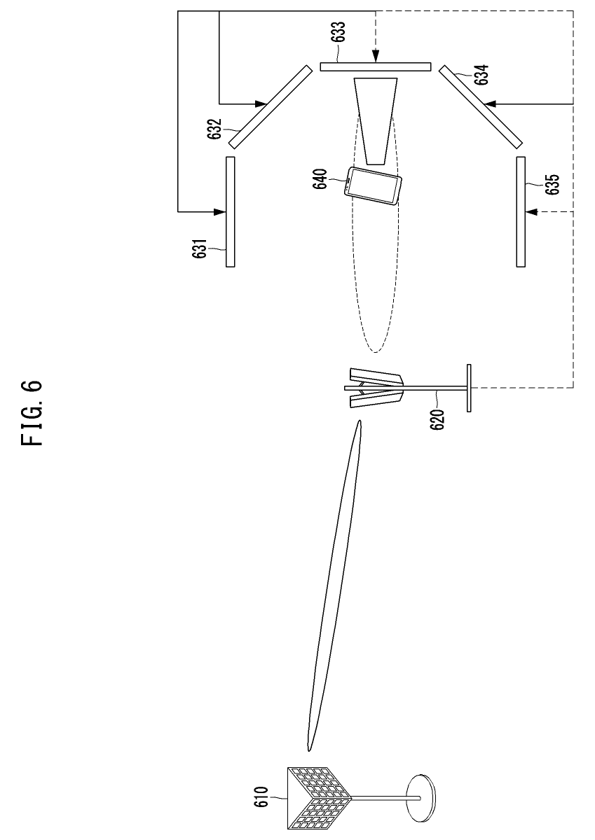

FIG. 6 is a conceptual diagram illustrating exemplary embodiments of a channel characteristic control method in a communication system.

Referring to FIG. 6, an NCR controller of an NCR may connect to a base station. The NCR controller may identify a state of a backhaul link during a process of connecting to the base station. For example, the NCR controller may determine the state of the backhaul link as a low-rank channel. A rank may refer to a number of effective independent paths (i.e. spatial multiplexing capability) of a multiple-input multiple-output (MIMO) channel matrix.

The base station may transmit a reference signal to the NCR. The NCR may receive the reference signal from the base station. The NCR may estimate a channel matrix H based on the received reference signal. The NCR may perform singular value decomposition (SVD) on the channel matrix and may determine a rank based on the number and magnitudes of singular values.

The base station may sequentially transmit reference signals or synchronization signals to the NCR controller by using a plurality of beams. The NCR controller may receive the reference signals or synchronization signals and may measure received signal strengths for the received reference signals or synchronization signals. The NCR controller may determine the number of received signal strengths equal to or greater than a threshold value, may determine a high-rank channel when the determined number is equal to or greater than a predetermined number, and may determine a low-rank channel when the determined number is less than the predetermined number.

In a channel characteristic control method, the base station 610 may transmit access link control information to the NCR controller 620. The access link control information may include access link beam configuration information. The access link beam configuration information may include information on a beam generation direction and a transmission power of an access link beam. The NCR controller may receive the access link control information from the base station.

The NCR controller may decode the received access link control information and may obtain the access link beam configuration information from the decoded access link control information. The NCR controller may control the NCR-Fwd unit according to the beam generation direction of the access link beam included in the access link beam configuration information. The NCR-Fwd unit may generate the access link beam under control of the NCR controller. The NCR-Fwd unit may transmit the generated access link beam to a terminal 640 with the transmission power.

The NCR controller may determine an RIS panel located in the beam generation direction of the access link beam according to a low-rank backhaul link state. The NCR controller may store position information of each RIS panel. The NCR controller may determine an RIS panel located in the beam generation direction of the access link beam based on information on the beam generation direction of the access link beam and information on positions of the RIS panels. For example, the RIS panel located in the beam generation direction of the access link beam may be an RIS panel denoted by reference numeral 633.

The NCR controller may generate RIS panel configuration information for the RIS panel 633. The RIS panel configuration information may include information such as a beam generation direction and a reflection power for the RIS panel. The NCR controller may transmit the RIS panel configuration information to the RIS panel 633. The RIS panel 633 may receive the RIS panel configuration information from the NCR controller.

The RIS panel 633 may reflect a beam received from the NCR-Fwd unit toward a terminal according to the beam generation direction and reflection power of the RIS panel based on the received RIS panel configuration information. The terminal may receive the access link beam from the NCR-Fwd unit and may receive a reflected access link beam from the RIS panel 633. Accordingly, the terminal may expect an array gain or a diversity gain in receiving a data signal through the access link beam. Alternatively, the RIS panel 633 may reflect a beam received from the terminal toward the NCR-Fwd unit according to the beam generation direction and reflection power of the RIS panel based on the received configuration information for each RIS panel.

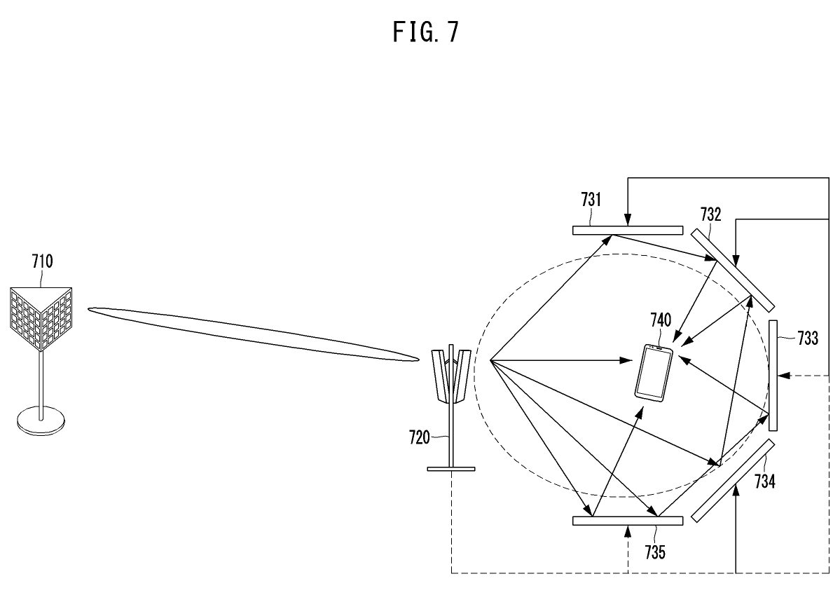

FIG. 7 is a conceptual diagram illustrating exemplary embodiments of a channel characteristic control method in a communication system.

Referring to FIG. 7, an NCR controller of an NCR may connect to a base station. The NCR controller may identify a state of a backhaul link during a process of connecting to the base station. For example, the NCR controller may determine the state of the backhaul link as a high-rank channel. In a channel characteristic control method, the base station 710 may transmit access link control information to the NCR controller 720. The access link control information may include access link beam configuration information for N access link beams. The access link beam configuration information for the N access link beams may include information on a beam generation direction and a transmission power for each of the N access link beams. N may be a positive integer. The NCR controller may receive the access link control information from the base station. The NCR controller may decode the received access link control information and may obtain the access link beam configuration information from the decoded access link control information.

The NCR controller may control an NCR-Fwd. unit according to the beam generation direction of each of the N access link beams included in the access link beam configuration information. The NCR-Fwd. unit may generate the N access link beams under control of the NCR controller. The NCR-Fwd. unit may transmit the generated N access link beams with the transmission powers to RIS panels (e.g. 731 to 735) and a terminal 740. Alternatively, the NCR-Fwd. unit may transmit the generated N access link beams with the transmission powers to some of the RIS panels (e.g. 731, 733, and 735) and the terminal 740.

Alternatively, the NCR controller may generate access link beam configuration information for P access link beams based on the access link beam configuration information for the N access link beams. The NCR controller may generate the access link beam configuration information for the P access link beams based on the access link beam configuration information for the N access link beams and information on positions of the RIS panels. P may be a positive integer greater than N.

The access link beam configuration information for the P access link beams may include information on a beam generation direction and a transmission power for each of the P access link beams. The NCR controller may control the NCR-Fwd unit according to the beam generation direction of each of the P access link beams included in the access link beam configuration information. The NCR-Fwd unit may generate the P access link beams under control of the NCR controller. The NCR-Fwd unit may transmit the generated P access link beams with the transmission powers to the RIS panels (e.g. 731 to 735) and the terminal 740. Alternatively, the NCR-Fwd unit may transmit the generated P access link beams with the transmission powers to some of the RIS panels (e.g. 731, 733, and 735) and the terminal 740.

The NCR controller may generate RIS panel configuration information for some (e.g. 731, 733, and 735) of the RIS panels or all (e.g. 731 to 735) of the RIS panels. The RIS panel configuration information may include information such as a beam generation direction and a reflection power for each RIS panel. The NCR controller may transmit the RIS panel configuration information to some (e.g. 731, 733, and 735) of the RIS panels or all (e.g. 731 to 735) of the RIS panels. Some (e.g. 731, 733, and 735) of the RIS panels or all (e.g. 731 to 735) of the RIS panels may receive the RIS panel configuration information from the NCR controller. The NCR controller may transmit the RIS panel configuration information to all or some of the RIS panels so that an access link channel of the terminal becomes a rich-scattering channel as much as possible.

Some (e.g. 731, 733, and 735) of the RIS panels or all (e.g. 731 to 735) of the RIS panels may reflect a beam received from the NCR-Fwd unit toward the terminal according to the beam generation direction and reflection power of each RIS panel based on the received RIS panel configuration information. The terminal may receive the access link beam from the NCR-Fwd unit and may receive reflected access link beams from some of the RIS panels (e.g. 731, 733, and 735) or all of the RIS panels (e.g. 731 to 735).

The terminal may receive all scattered signals. An access link channel of the terminal may be a full-rank channel or a channel having a high rank equivalent to a full rank. The terminal may receive a data signal through a high rank, that is, through multiple layers. Some (e.g. 731, 733, and 735) of the RIS panels or all (e.g. 731 to 735) of the RIS panels may reflect a beam received from the terminal toward the NCR-Fwd unit according to a beam generation direction and reflection power of each RIS panel based on the received configuration information for each RIS panel.

Meanwhile, the NCR controller of the NCR may connect to the base station. The NCR controller may identify a state of a backhaul link during a process of connecting to the base station. For example, the NCR controller may determine the state of the backhaul link as a high-rank channel. In the channel characteristic control method, the base station may transmit access link control information to the NCR controller. The access link control information may include access link beam configuration information for N access link beams. The access link beam configuration information for the N access link beams may include information on a beam generation direction and a transmission power for each of the N access link beams. N may be a positive integer. The NCR controller may receive the access link control information from the base station. The NCR controller may decode the received access link control information and may obtain the access link beam configuration information from the decoded access link control information.

The NCR controller may control the NCR-Fwd unit according to the beam generation direction of each of N access link beams included in access link beam configuration information. The NCR-Fwd unit may generate the N access link beams under control of the NCR controller. The NCR-Fwd unit may transmit the generated N access link beams with the transmission powers to all RIS panels and the terminal. Alternatively, the NCR-Fwd unit may transmit the generated N access link beams with the transmission powers to some of the RIS panels and the terminal.

Alternatively, the NCR controller may generate access link beam configuration information for P access link beams based on the access link beam configuration information for the N access link beams. The NCR controller may generate the access link beam configuration information for the P access link beams based on the access link beam configuration information for the N access link beams and information on positions of the RIS panels. P may be a positive integer greater than N.

The access link beam configuration information for the P access link beams may include information on a beam generation direction and a transmission power for each of the P access link beams. The NCR controller may control the NCR-Fwd unit according to the beam generation direction of each of the P access link beams included in the access link beam configuration information. The NCR-Fwd unit may generate the P access link beams under control of the NCR controller.

The NCR-Fwd unit may transmit the generated P access link beams with the transmission powers to all RIS panels and the terminal. Alternatively, the NCR-Fwd unit may transmit the generated P access link beams with the transmission powers to some of the RIS panels and the terminal. The NCR controller may generate RIS panel configuration information for some or all of the RIS panels. In this case, the NCR controller may group reflection elements for each of the RIS panels and may configure a plurality of reflection element units.

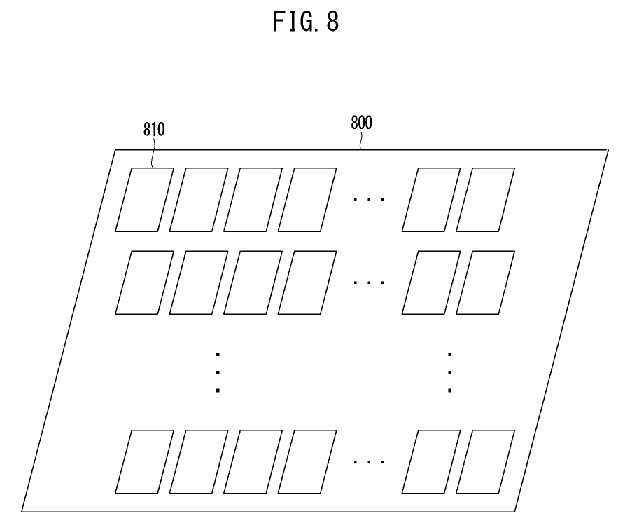

FIG. 8 is a conceptual diagram illustrating exemplary embodiments of an RIS panel.

Referring to FIG. 8, an NCR controller may group reflection elements for an RIS panel 800 and may configure a plurality of reflection element units 810. RIS panel configuration information may include information on a beam generation direction and a reflection power of a reflection element unit of the RIS panel. The NCR controller may transmit the RIS panel configuration information to some or all of the RIS panels. Some or all of the RIS panels may receive the RIS panel configuration information from the NCR controller. The NCR controller may transmit the RIS panel configuration information to all or some of the RIS panels so that an access link channel of the terminal becomes a rich-scattering channel as much as possible.

Some or all of the RIS panels may reflect a beam received from the NCR-Fwd unit toward the terminal according to beam generation directions and reflection powers of reflection element units of each RIS panel based on the received RIS panel configuration information. The terminal may receive an access link beam from the NCR-Fwd unit and may receive reflected access link beams from reflection element units of some or all of the RIS panels.

The terminal may receive all scattered signals. An access link channel of the terminal may be a full-rank channel or a channel having a high rank equivalent to a full rank. The terminal may receive a data signal through a high rank, that is, through multiple layers. Some (e.g. 731, 733, and 735) of the RIS panels or all (e.g. 731 to 735) of the RIS panels may reflect a beam received from the terminal toward the NCR-Fwd unit according to a beam generation direction and reflection power of each RIS panel based on the received configuration information for each RIS panel.

The NCR controller may design configuration information for each reflection element unit to have a random or pseudo-random value so that the access link channel has characteristics of a rich-scattering channel. The number of RIS panels may increase. The number of reflection element units per RIS panel may increase. Accordingly, theoretically, infinitely many scatterings may be generated. In this case, the access link channel may approximate an independent and identically distributed (IID) complex Gaussian multiple-input multiple-output (MIMO) channel.

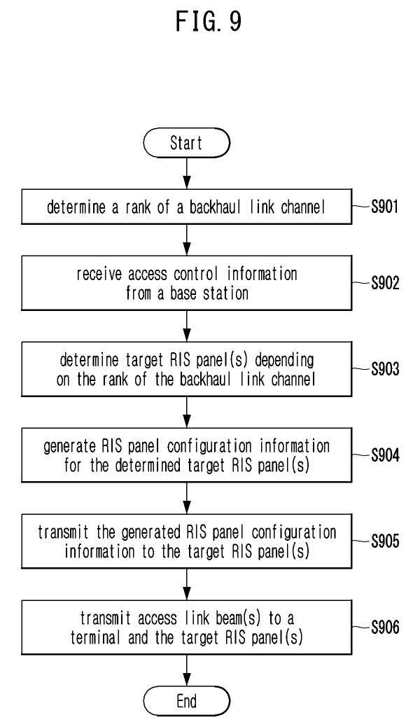

FIG. 9 is a flowchart illustrating exemplary embodiments of a channel characteristic control method in a communication system.

Referring to FIG. 9, an NCR controller of an NCR may connect to a base station. The NCR controller may determine a rank of a backhaul link during a process of connecting to the base station (S901). For example, the NCR controller may determine the rank of the backhaul link as a low-rank channel. The base station may transmit access link control information to the NCR controller. The access link control information may include access link beam configuration information. The access link beam configuration information may include information on a beam generation direction and a transmission power of an access link beam. The NCR controller may receive the access link control information from the base station (S902).

The NCR controller may decode the received access link control information and may obtain the access link beam configuration information from the decoded access link control information. The NCR controller may control an NCR-Fwd unit according to the beam generation direction of the access link beam included in the access link beam configuration information. The NCR-Fwd unit may generate the access link beam under control of the NCR controller. The NCR-Fwd unit may transmit the generated access link beam to the terminal using transmission power.

The NCR controller may determine an RIS panel located in the beam generation direction of the access link beam according to a low-rank backhaul link state (S903). The NCR controller may store position information of each RIS panel. The NCR controller may determine an RIS panel located in the beam generation direction of the access link beam based on information on the beam generation direction of the access link beam and information on positions of the RIS panels. The NCR controller may generate RIS panel configuration information for the determined RIS panel (S904). The RIS panel configuration information may include information on a beam generation direction and a reflection power of the RIS panel. The NCR controller may transmit the RIS panel configuration information to the RIS panel (S905). The RIS panel may receive the RIS panel configuration information from the NCR controller.

The NCR controller may transmit the access link beam to the RIS panel using the NCR-Fwd unit (S906). The RIS panel may reflect the beam received from the NCR-Fwd unit toward the terminal according to the beam generation direction and the reflection power of the RIS panel based on the received RIS panel configuration information. The terminal may receive the access link beam from the NCR-Fwd unit and may receive the reflected access link beam from the RIS panel.

Meanwhile, the NCR controller may determine a channel of the backhaul link as a high-rank channel. The base station may transmit access link control information to the NCR controller. The access link control information may include access link beam configuration information for N access link beams. The access link beam configuration information for the N access link beams may include information on a beam generation direction and a transmission power for each of the N access link beams. N may be a positive integer. The NCR controller may receive the access link control information from the base station (S902). The NCR controller may decode the received access link control information and may obtain the access link beam configuration information from the decoded access link control information.

The NCR controller may control the NCR-Fwd unit according to the beam generation direction of each of the N access link beams included in the access link beam configuration information. The NCR-Fwd unit may generate the N access link beams under control of the NCR controller. The NCR-Fwd unit may transmit the generated N access link beams with the transmission powers to the RIS panels and the terminal. Alternatively, the NCR-Fwd unit may transmit the generated N access link beams with the transmission powers to some of the RIS panels and the terminal.

The NCR controller may generate access link beam configuration information for P access link beams based on the access link beam configuration information for the N access link beams. The NCR controller may generate the access link beam configuration information for the P access link beams based on the access link beam configuration information for the N access link beams and information on positions of the RIS panels. P may be a positive integer greater than N.

The access link beam configuration information for the P access link beams may include information on a beam generation direction and a transmission power for each of the P access link beams. The NCR controller may control the NCR-Fwd unit according to the beam generation direction of each of the P access link beams included in the access link beam configuration information. The NCR-Fwd unit may generate the P access link beams under control of the NCR controller. The NCR-Fwd unit may transmit the generated P access link beams with the transmission powers to the RIS panels and the terminal. Alternatively, the NCR-Fwd unit may transmit the generated P access link beams with the transmission powers to some of the RIS panels and the terminal.

The NCR controller may determine some or all of the RIS panels as target RIS panels (S903). The NCR controller may generate RIS panel configuration information for some or all of the RIS panels (S904). The RIS panel configuration information may include information on a beam generation direction and a reflection power of each RIS panel. The NCR controller may transmit the RIS panel configuration information to some or all of the RIS panels (S905). Some or all of the RIS panels may receive the RIS panel configuration information from the NCR controller.

The NCR controller may transmit an access link beam to some or all of the RIS panels using the NCR-Fwd unit (S906). Some or all of the RIS panels may reflect the beam received from the NCR-Fwd unit toward the terminal according to the beam generation direction and the reflection power of each RIS panel based on the received RIS panel configuration information. The terminal may receive the access link beam from the NCR-Fwd unit and may receive reflected access link beams from some or all of the RIS panels.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a network controlled repeater (NCR), comprising:
determining a rank of a backhaul link between a base station and the NCR;
receiving access link configuration information from the base station;
determining, among a plurality of reconfigurable intelligent surface (RIS) panels, at least one RIS panel according to the determined rank and the access link configuration information;
transmitting RIS configuration information to the at least one RIS panel; and
transmitting at least one signal to the at least one RIS panel through at least one access link beam.

2. The method of claim 1, wherein the determining of the rank of the backhaul link comprises:
receiving a reference signal from the base station; and
determining the rank of the backhaul link based on the reference signal.

3. The method of claim 2, wherein the determining of the rank of the backhaul link based on the reference signal comprises:
estimating a channel matrix based on the reference signal;
performing singular value decomposition (SVD) on the channel matrix to generate singular values; and
determining the rank based on a number and magnitudes of the singular values.

4. The method of claim 1, wherein the determining of the at least one RIS panel according to the determined rank and the access link configuration information comprises:
based on the determined rank being a low rank, acquiring at least one beam generation direction of at least one access link beam from the access link configuration information; and
determining, among the plurality of RIS panels, an RIS panel located in the at least one generation direction as the at least one RIS panel.

5. The method of claim 1, wherein the determining of the at least one RIS panel according to the determined rank and the access link configuration information comprises:
based on the determined rank being a high rank, configuring N access link beams based on the access link configuration information; and
determining, among the plurality of RIS panels, P RIS panels as the at least one RIS panel with reference to the N access link beams,
where N and P are positive integers, and P is greater than or equal to N.

6. The method of claim 1, wherein the transmitting of the RIS configuration information to the at least one RIS panel comprises:
generating the RIS configuration information including at least one of a reflection beam generation direction or a reflection power of the at least one RIS panel; and
transmitting the generated RIS configuration information to the at least one RIS panel.

7. The method of claim 1, wherein the transmitting of the RIS configuration information to the at least one RIS panel comprises:
grouping reflection elements of the at least one RIS panel to form at least one reflection element unit;
generating the RIS configuration information including at least one of a reflection beam generation direction or a reflection power of the at least one reflection element unit; and
transmitting the generated RIS configuration information to the at least one RIS panel.

8. The method of claim 1, further comprising:
receiving, from the base station, the RIS configuration information for the at least one RIS panel; and
transmitting the RIS configuration information to the at least one RIS panel.

9. A network controlled repeater (NCR) comprising at least one processor, wherein the at least one processor causes the NCR to perform:
determining a rank of a backhaul link between a base station and the NCR;
receiving access link configuration information from the base station;
determining, among a plurality of reconfigurable intelligent surface (RIS) panels, at least one RIS panel according to the determined rank and the access link configuration information;
transmitting RIS configuration information to the at least one RIS panel; and
transmitting at least one signal to the at least one RIS panel through at least one access link beam.

10. The NCR of claim 9, wherein in the determining of the rank of the backhaul link, the at least one processor causes the NCR to perform:
receiving a reference signal from the base station; and
determining the rank of the backhaul link based on the reference signal.

11. The NCR of claim 9, wherein in the determining of the at least one RIS panel according to the determined rank and the access link configuration information, the at least one processor causes the NCR to perform:
based on the determined rank being a low rank, acquiring at least one beam generation direction of at least one access link beam from the access link configuration information; and
determining, among the plurality of RIS panels, an RIS panel located in the at least one generation direction as the at least one RIS panel.

12. The NCR of claim 9, wherein in the determining of the at least one RIS panel according to the determined rank and the access link configuration information, the at least one processor causes the NCR to perform:
based on the determined rank being a high rank and the access link configuration information indicating at least one access link beam, configuring N access link beams based on the indicated at least one access link beam; and
determining, among the plurality of RIS panels, P RIS panels as the at least one RIS panel with reference to the N access link beams,
where N and P are positive integers, and P is greater than or equal to N.

13. The NCR of claim 9, wherein in the transmitting of the RIS configuration information to the at least one RIS panel, the at least one processor causes the NCR to perform:
grouping reflection elements of the at least one RIS panel to form at least one reflection element unit;
generating the RIS configuration information including at least one of a reflection beam generation direction or a reflection power of the at least one reflection element unit; and
transmitting the generated RIS configuration information to the at least one RIS panel.

14. The NCR of claim 9, wherein the at least one processor further causes the NCR to perform:
receiving, from the base station, the RIS configuration information for the at least one RIS panel; and
transmitting the RIS configuration information to the at least one RIS panel.
